(19) United States
(12) Patent Application Publication
(10) Pub. No.: US 2025/0047201 A1
(43) Pub. Date: Feb. 6, 2025

(54) POWER CONVERTER AND POWER CONVERSION METHOD CAPABLE OF BALANCING ENERGY AND HYBRID POWER SUPPLY

(71) Applicant: DELTA ELECTRONICS, INC., Taoyuan City (TW)

(72) Inventors: Hung-Chieh LIN, Taoyuan City (TW); Yi-Ping HSIEH, Taoyuan City (TW); Hsin-Chih CHEN, Taoyuan City (TW); Hung-Yu HUANG, Taoyuan City (TW)

(21) Appl. No.: 18/470,950

(22) Filed: Sep. 20, 2023

(30) Foreign Application Priority Data
Aug. 1, 2023 (CN) 202310954928.2

(51) Int. Cl. H02M 3/158; H02M 1/00; H02M 5/293

(52) U.S. Cl. CPC H02M 3/158; H02M 1/0003; H02M 1/0083; H02M 5/2932

(57) ABSTRACT

A power converter is coupled between a power source and multiple loads, and the power converter includes a first switch module. The switch module includes an inductor, a first switch, a second switch, a third switch, and a fourth switch. The first switch, the second switch, the third switch, and the fourth switch are configured to be turned on or turned off so that the inductor is stored energy or released energy to converter the power source into multiple voltages to the multiple loads.

### BACKGROUND

### Technical Field

The present disclosure relates to an energy balancing circuit and a method of adjusting capacitor voltages, and more particularly to a power converter with multiple output capacitors and a method of adjusting capacitor voltages.

### Description of Related Art

In recent years, non-isolated power converters, such as bidirectional power converters and single-to-multiple power converters, have been widely used in uninterruptible power systems, renewable energy systems, fuel cells, and hybrid vehicles. The power converter can provide a single power supply to multiple loads, or transfer the power from one load to another load so as to achieve the purpose of energy balance and hybrid power supply. In the above occasions, the design goals of the power converter include at least: 1. high conversion efficiency; 2. ability to withstand high current; 3. low input current ripple; 4. small size and low cost. Therefore, how to design the single-to-multiple power converter that is suitable for the above occasions and meets the design goals has become a critical topic in this field.

### SUMMARY

An objective of the present disclosure is to provide a power converter. The power converter is coupled between a power source and multiple loads. The power converter includes a first switch module. The first switch module includes an inductor, a first switch, a second switch, a third switch, and a fourth switch. The inductor includes a first end and a second end. The first switch includes a first end connected to a first input end, and a second end connected to the first end of the inductor. The second switch incudes a first end connected to the second end of the inductor, and a second end connected to a second input end. The third switch includes a first end connected to a first output end, and a second end connected to the first end of the second switch and the second end of the inductor. The fourth switch includes a first end connected to the second end of the first switch and the first end of the inductor, and a second end connected to a second output end. The first switch, the second switch, the third switch, and the fourth switch are configured to be turned on or off, such that the inductor stores or releases energy to convert the power source into multiple voltages to the multiple loads.

Another objective of the present disclosure is to provide a power conversion method. The method includes steps of: detecting multiple voltages of multiple loads to determine one of a first operation mode, a second operation mode, a third operation mode, a fourth operation mode, a fifth operation mode, and a sixth operation mode, and controlling the turn-on and turn-off of the first switch, the second switch, the third switch, and the fourth switch, such that the inductor stores or releases energy to respectively build a first voltage, a second voltage, and a third voltage to the multiple loads according to one of the six operation modes.

Accordingly, the power converter and power conversion method proposed in the present disclosure have the following features and advantages: 1. by controlling the voltages of the capacitor units through duty cycle adjustment of the switches can reduce the number of components to achieve the advantages of small size and low cost; 2. through the energy storage and release of the inductor, and the control of multiple switches, the energy transfer between the voltages of the capacitor units can be controlled, and the voltages of the capacitor units can be adjusted to meet the requirements of different loads.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a circuit diagram of a power converter according to a first embodiment of the present disclosure.

FIG. 2 is a schematic diagram of the power converter in a first operation mode according to the present disclosure.

FIG. 3 is a schematic diagram of the power converter in a second operation mode according to the present disclosure.

FIG. 4 is a schematic diagram of the power converter in a third operation mode according to the present disclosure.

FIG. 5 is a schematic diagram of the power converter in a fourth operation mode according to the present disclosure.

FIG. 6 is a schematic diagram of the power converter in a fifth operation mode according to the present disclosure.

FIG. 7 is a schematic diagram of the power converter in a sixth operation mode according to the present disclosure.

FIG. 8 is a circuit diagram of the power converter according to a second embodiment of the present disclosure.

FIG. 9 is a circuit diagram of the power converter according to a third embodiment of the present disclosure.

FIG. 10 is a circuit diagram of the power converter according to a fourth embodiment of the present disclosure.

FIG. 11 is a circuit diagram of the power converter according to a fifth embodiment of the present disclosure.

FIG. 12 is a circuit diagram of the power converter according to a sixth embodiment of the present disclosure.

FIG. 13 is a flowchart of a power conversion method according to the present disclosure.

### DETAILED DESCRIPTION

Reference will now be made to the drawing figures to describe the present disclosure in detail.

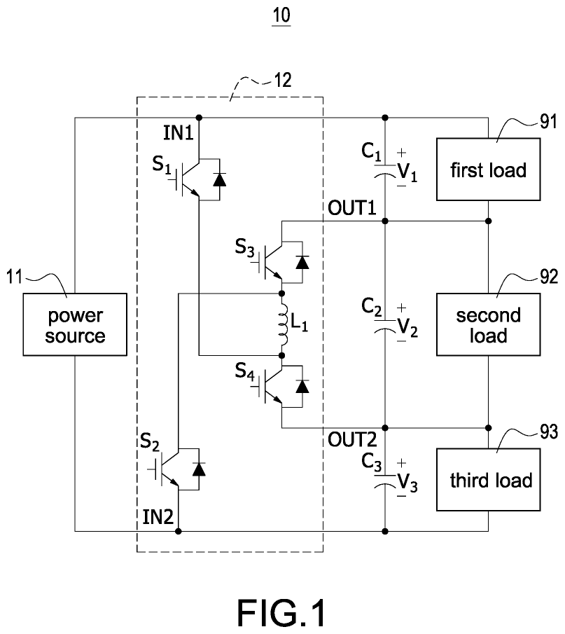

Please refer to FIG. 1, which shows a circuit diagram of a power converter according to a first embodiment of the present disclosure. The power converter 10 is coupled between a power source 11 and multiple loads (including a first load 91, a second load 92, and a third load 93). The power converter 10 includes a first switch module 12. As shown in FIG. 1, the first switch module 12 includes an inductor L₁, a first switch S₁, a second switch S₂, a third switch S₃, and a fourth switch S₄. In addition, the first load 91 is connected between a first input end IN1 and a first output end OUT1, the second load 92 is connected between the first output end OUT1 and a second output end OUT2, and the third load 93 is connected between a second input end IN2 and the second output end OUT2.

The first switch S₁ has a first end and a second end, in which the first end of the first switch S₁ is connected to the first input end IN1, and the second end of the first switch S₁ is connected to a first end of the inductor L₁. The second switch S₂ has a first end and a second end, in which the first end of the second switch S₂ is connected to a second end of the inductor L₁, and the second end of the second switch S₂ is connected to the second input end IN2. The third switch S₃ has a first end and a second end, in which the first end of the third switch S₃ is connected to the first output end OUT1, and the second end of the third switch S₃ is connected to the first end of the second switch S₂ and the second end of the inductor L₁. The fourth switch S₄ has a first end and a second end, in which the first end of the fourth switch S₄ is connected to the second end of the first switch S₁ and the first end of the inductor L₁, and the second end of the fourth switch S₄ is connected to the second output end OUT2.

In particular, the first switch S₁, the second switch S₂, the third switch S₃, and the fourth switch S₄ are configured to be turned on or off, such that the inductor L₁ stores or releases energy, so as to convert the power source 11 into multiple voltages to the multiple loads 91, 92, 93.

As shown in FIG. 1, the power converter 10 further includes a first capacitor C₁, a second capacitor C₂, and a third capacitor C₃. The first capacitor C₁ is connected between the first input end IN1 and the first output end OUT1, and configured to build a first voltage V₁. The second capacitor C₂ is connected between the first output end OUT1 and the second output end OUT2, and configured to build a second voltage V₂. The third capacitor C₃ is connected between the second input end IN2 and the second output end OUT2, and configured to build a third voltage V₃.

In one embodiment, the power source 11 is a DC (direct-current) power source, and connected between the first input end IN1 and the second input end IN2. The first switch S₁, the second switch S₂, the third switch S₃, and the fourth switch S₄ are N-type synchronous rectification switches.

In one embodiment, the power converter 10 is controlled by a controller (not shown), such as a digital signal processor, a programmable logic controller, a microcontroller, and the like. The controller is configured to detect voltage change rates of the multiple loads (or capacitors) so as to determine that the power converter 10 executes one of the first to sixth operation modes. Specifically, when energy drop rate of one of the loads is significantly lower than that of the other loads, the energy stored in the load with the lowest energy drop rate needs to be transferred to the load with the highest energy drop rate. In other words, energy balance and hybrid power supply can be achieved by transferring the energy stored in the load with the least power consumption to the load with the most power consumption. In other embodiments, the controller receives a user instruction to control the power converter 10 to execute which operation mode so as to realize energy scheduling.

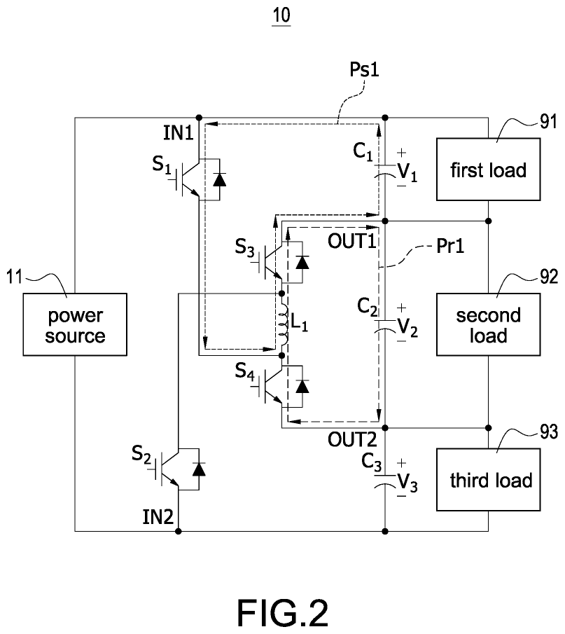

Please refer to FIG. 2, which shows a schematic diagram of the power converter in a first operation mode according to the present disclosure. As shown in FIG. 2, based on the first switch S₁ being turned on, the inductor L₁ stores energy stored in the first capacitor C₁ (as shown by a first energy-storing path Ps1), and a voltage across the inductor L₁ is the first voltage V₁. Based on the first switch S₁ being turned off, the energy stored in the inductor L₁ releases to the second capacitor C₂ (as shown by a first energy-releasing path Pr1) to build the second voltage V₂ on the second capacitor C₂. In the first operation mode of the power converter, energy can be transferred from the first capacitor C₁ to the second capacitor C₂, and the voltage of the second capacitor C₂ can be stabilized. In one embodiment, the condition for the power converter 10 to execute the first operation mode includes at least one of E₁>E₃>E₂ and E₁>>E₂, wherein E₁, E₂, and E₃ are respectively the energy stored in the first load 91, the second load 92, and the third load 93. In the first operation mode, since the first energy-storing path Ps1 and the first energy-releasing path Pr1 pass through a body diode of the third switch S₃, the third switch S₃ may be replaced by a synchronous rectification switch or a diode.

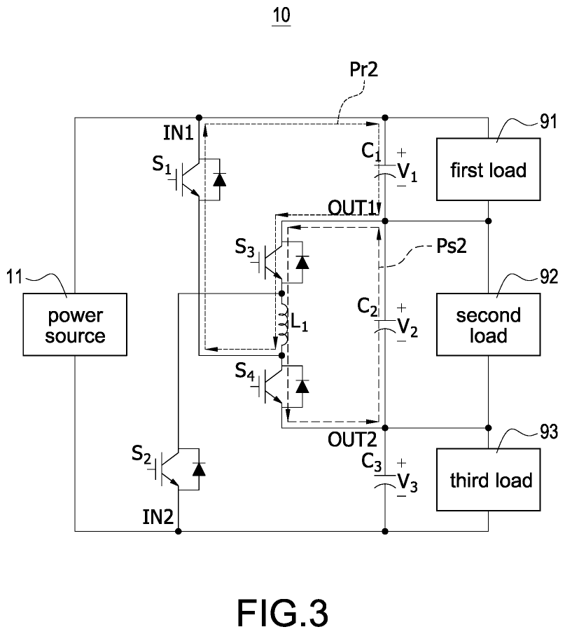

Please refer to FIG. 3, which shows a schematic diagram of the power converter in a second operation mode according to the present disclosure. As shown in FIG. 3, based on the third switch S₃ being turned on and the fourth switch S₄ being turned on, the inductor L₁ stores energy stored in the second capacitor C₂ (as shown by a second energy-storing path Ps2) to build the second voltage V₂ on the inductor L₁. Based on the fourth switch S₄ being turned off and the third switch S₃ being still turned on, the energy stored in the inductor L₁ releases to the first capacitor C₁ (as shown by a second energy-releasing path Pr2) to build the first voltage V₁ on the first capacitor C₁. In the second operation mode of the power converter, energy can be transferred from the second capacitor C₂ to the first capacitor C₁, and the voltage of the first capacitor C₁ can be stabilized. In one embodiment, the condition for the power converter 10 to execute the second operation mode includes at least one of E₂>E₃>E₁ and E₂>>E₁. In the second operation mode, since the second energy-releasing path Pr2 passes through a body diode of the first switch S₁, the first switch S₁ may be replaced by a synchronous rectification switch or a diode.

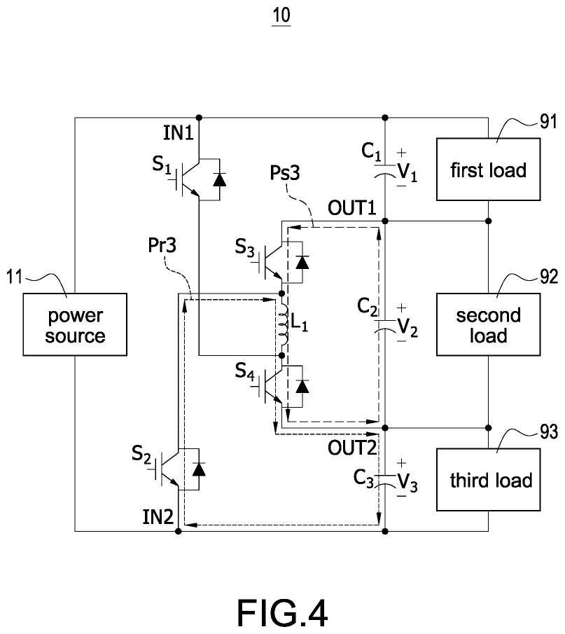

Please refer to FIG. 4, which shows a schematic diagram of the power converter in a third operation mode according to the present disclosure. As shown in FIG. 4, based on the third switch S₃ being turned on and the fourth switch S₄ being turned on, the inductor L₁ stores energy stored in the second capacitor C₂ (as shown by a third energy-storing path Ps3) to build the second voltage V₂ on the inductor L₁. Based on the third switch S₃ being turned off and the fourth switch S₄ being still turned on, the energy stored in the inductor L₁ releases to the third capacitor C₃ (as shown by a third energy-releasing path Pr3) to build the third voltage V₃ on the third capacitor C₃. In the third operation mode of the power converter, energy can be transferred from the second capacitor C₂ to the third capacitor C₃, and the voltage of the third capacitor C₃ can be stabilized. In one embodiment, the condition for the power converter 10 to execute the third operation mode includes at least one of E₂>E₁>E₃ and E₂>>E₃. In the third operation mode, since the third energy-releasing path Pr3 passes through a body diode of the second switch S₂, the second switch S₂ may be replaced by a synchronous rectification switch or a diode.

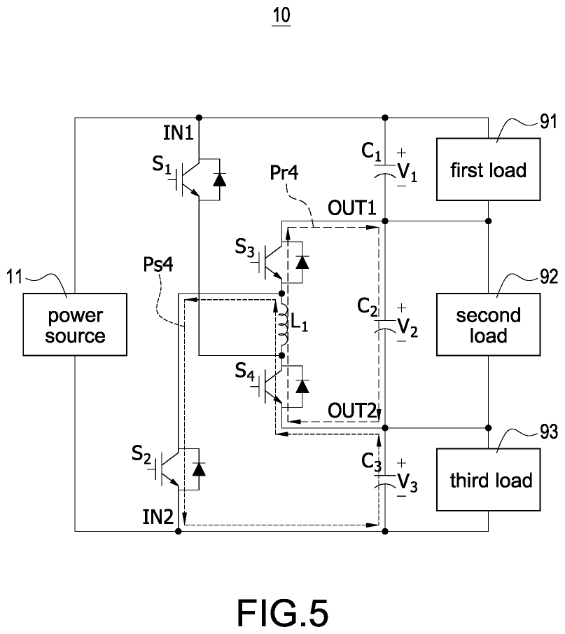

Please refer to FIG. 5, which shows a schematic diagram of the power converter in a fourth operation mode according to the present disclosure. As shown in FIG. 5, based on the second switch S₂ being turned on, the inductor L₁ stores energy stored in the third capacitor C₃ (as shown by a fourth energy-storing path Ps4) to build the third voltage V₃ on the inductor L₁. Based on the second switch S₂ being turned off, the energy stored in the inductor L₁ releases to the second capacitor C₂ (as shown by a fourth energy-releasing path Pr4) to build the second voltage V₂ on the second capacitor C₂. In the fourth operation mode of the power converter, energy can be transferred from the third capacitor C₃ to the second capacitor C₂, and the voltage of the second capacitor C₂ can be stabilized. In one embodiment, the condition for the power converter 10 to execute the fourth operation mode includes at least one of E₃>E₁>E₂ and E₃>>E₂. In the fourth operation mode, since the fourth energy-storing path Ps4 and the fourth energy-releasing path Pr4 pass through a body diode of the fourth switch S₄, the fourth switch S₄ may be replaced by a synchronous rectification switch or a diode.

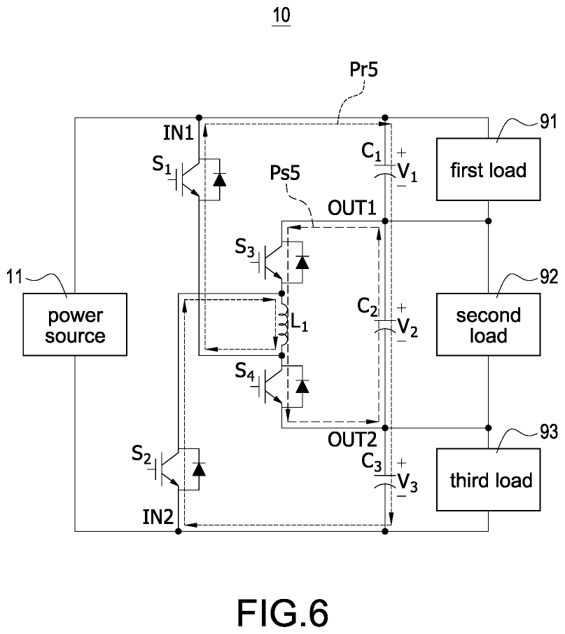

Please refer to FIG. 6, which shows a schematic diagram of the power converter in a fifth operation mode according to the present disclosure. As shown in FIG. 6, based on the third switch S₃ being turned on and the fourth switch S₄ being turned on, the inductor L₁ stores energy stored in the second capacitor C₂ (as shown by a fifth energy-storing path Ps5) to build the second voltage V₂ on the inductor L₁. Based on the third switch S₃ being turned off and the fourth switch S₄ being turned off, the energy stored in the inductor L₁ releases to the first capacitor C₁, the second capacitor C₂, and the third capacitor C₃ (as shown by a fifth energy-releasing path Pr5), to build the first voltage V₁ on the first capacitor C₁, the second voltage V₂ on the second capacitor C₂, and the third voltage V₃ on the third capacitor C₃, and thus a voltage of V₁+V₂+V₃ is built on a series path formed by the three capacitors. In the fifth operation mode of the power converter, energy can be transferred from the second capacitor C₂ to the first capacitor C₁ and the third capacitor C₃, and the voltages of the first capacitor C₁ and the third capacitor C₃ can be stabilized. In one embodiment, the condition for the power converter 10 to execute the fifth operation mode includes at least one of E₂>E₁=E₃ and E₂>>E₁=E₃. In the fifth operation mode, since the fifth energy-releasing path Pr5 passes through a body diode of the first switch S₁ and a body diode of the second switch S₂, the first switch S₁ and the second switch S₂ may be replaced by a synchronous rectification switch or a diode.

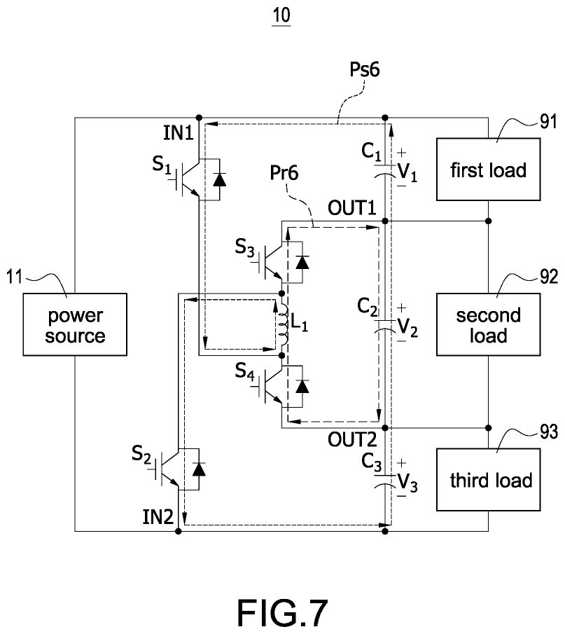

Please refer to FIG. 7, which shows a schematic diagram of the power converter in a sixth operation mode according to the present disclosure. As shown in FIG. 7, based on the first switch S₁ being turned on and the second switch S₂ being turned on, the inductor L₁ stores energy stored in the first capacitor C₁, the second capacitor C₂, and the third capacitor C₃ (as shown by a sixth energy-storing path Ps6) to build a voltage of V₁+V₂+V₃ on the inductor L₁ is a voltage of V₁+V₂+V. Based on the first switch S₁ being turned off or the second switch S₂ being turned off, the energy stored in the inductor L₁ releases to the second capacitor C₂ (as shown by a sixth energy-releasing path Pr6) to build the second voltage V₂ on the second capacitor C₂. In the sixth operation mode of the power converter, energy can be transferred from the first capacitor C₁, the second capacitor C₂, and the third capacitor C₃ to the second capacitor C₂, and the voltage of the second capacitor C₂ can be stabilized. In one embodiment, the condition for the power converter 10 to execute the sixth operation mode includes at least one of E₂<E₁=E₃ and E₂<<E₁=E₃. In the sixth operation mode, since the sixth energy-releasing path Pr6 passes through a body diode of the third switch S₃ and a body diode of the fourth switch S₄, the third switch S₃ and the fourth switch S₄ may be replaced by a synchronous rectification switch or a diode.

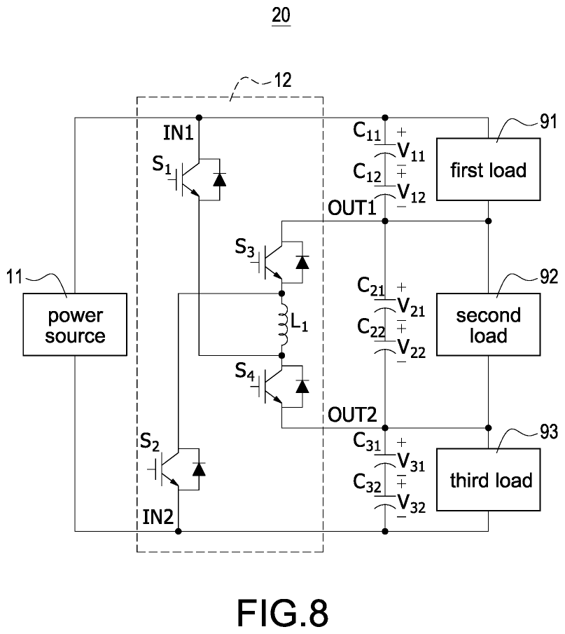

Please refer to FIG. 8, which shows a circuit diagram of the power converter 20 according to a second embodiment of the present disclosure. A major difference between the second embodiment and the first embodiment shown in FIG. 1 is that the former provides a multi-capacitor cascade structure. In this embodiment, the multi-capacitor cascade structure includes a first capacitor string, a second capacitor string, and a third capacitor string. The first capacitor string includes multiple first capacitors C₁₁, C₁₂, connected between the first input end IN1 and the first output end OUT1, and configured to build a first voltage V₁ including multiple voltages V₁₁, V₁₂. The second capacitor string includes multiple second capacitors C₂₁, C₂₂, connected between the first output end OUT1 and the second output end OUT2, and configured to build a second voltage V₂ including multiple voltages V₂₁, V₂₂. The third capacitor string includes multiple third capacitors C₃₁, C₃₂, connected between the second input end IN2 and the second output end OUT2, and configured to build a third voltage V₃ including multiple voltages V₃₁, V₃₂. In this embodiment, the power source 11 is a DC power source connected between the first input end IN1 and the second input end IN2. The first switch S₁, the second switch S₂, the third switch S₃, and the fourth switch S₄ are N-type synchronous rectification switches.

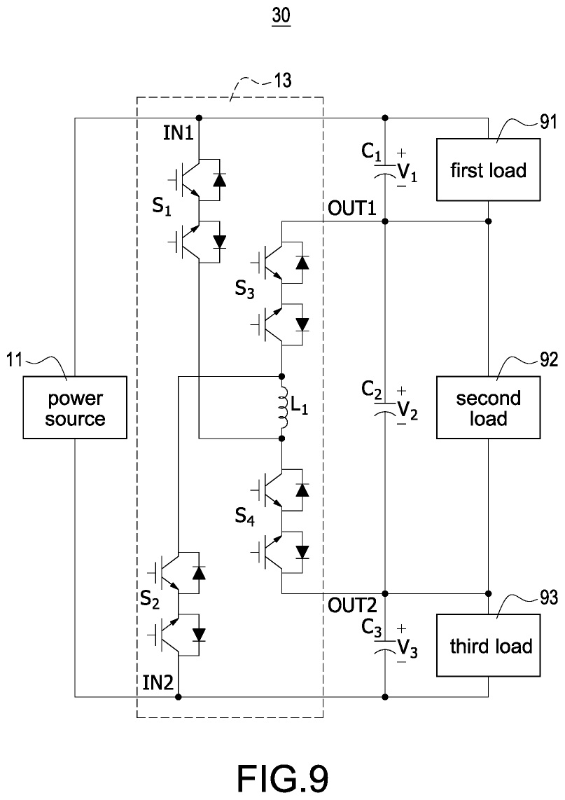

Please refer to FIG. 9, which shows a circuit diagram of the power converter 30 according to a third embodiment of the present disclosure. In this embodiment, the power source 11 is an AC (alternating-current) power source, and the first switch S₁, the second switch S₂, the third switch S₃, and the fourth switch S₄ are back-to-back bidirectional switches. Therefore, adapting to different positive and negative half cycles of the AC power source, the purpose of capacitor voltage adjustment can be achieved through the back-to-back bidirectional switch.

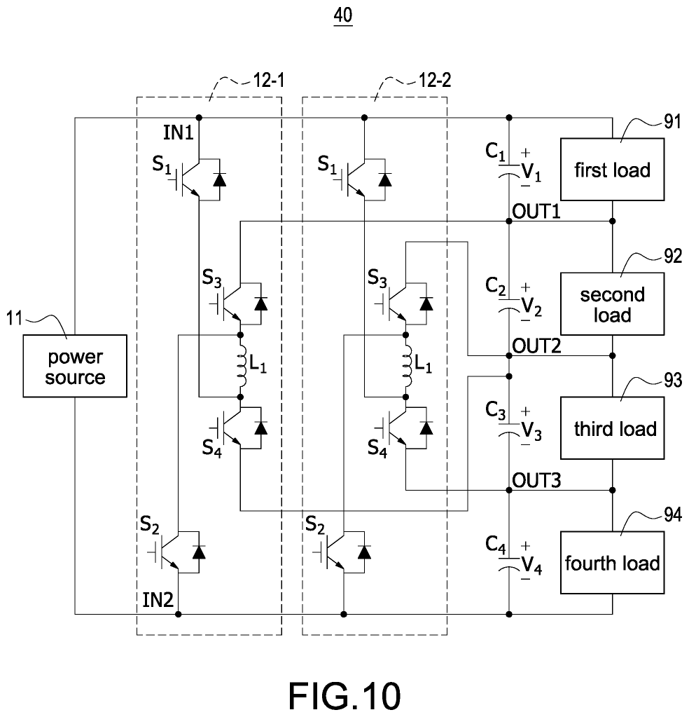

Please refer to FIG. 10, which shows a circuit diagram of the power converter 40 according to a fourth embodiment of the present disclosure. A major difference between the fourth embodiment and the first embodiment shown in FIG. 1 is that the former provides two switch modules, that is, a first switch module 12-1 and a second switch module 12-2, and four capacitors C₁, C₂, C₃, C₄, that is, a fourth capacitor C₄ is extra compared with the above-mentioned embodiments. In this embodiment, the first switch module 12-1 is corresponding to the first switch module 12 in the first embodiment. A first end of the third switch S₃ of the second switch module 12-2 is connected to the second output end OUT2, and a second end of the fourth switch S₄ of the second switch module 12-2 is connected to the third output end OUT3. The fourth capacitor C₄ is connected between the third output end OUT3 and the second input end IN2, and configured to configured to build a fourth voltage V₄. The fourth load 94 is connected between the third output end OUT3 and the second input end IN2.

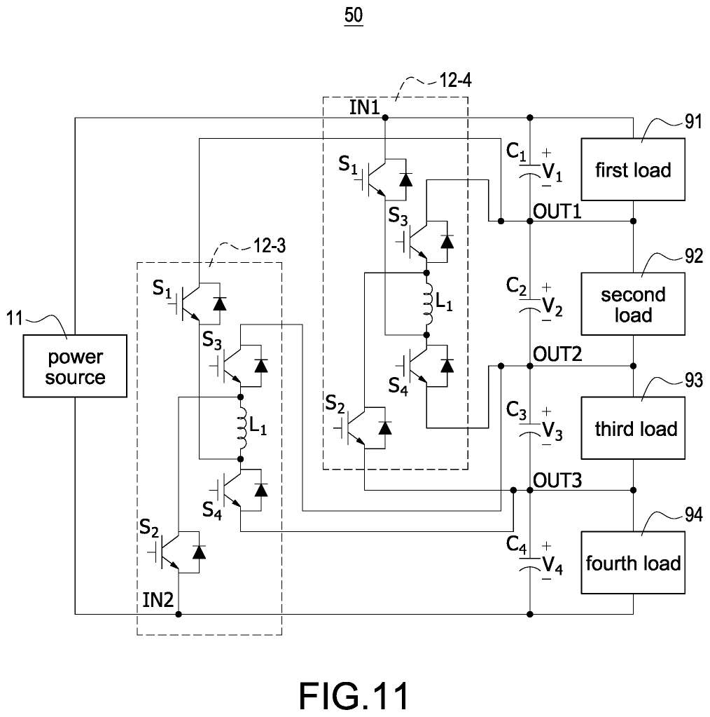

Please refer to FIG. 11, which shows a circuit diagram of the power converter 50 according to a fifth embodiment of the present disclosure. The power converter 50 is coupled between the power source 11 and multiple loads (including a first load 91, a second load 92, a third load 93, and a fourth load 94). The power converter 10 includes a first switch module 12-3. As shown in FIG. 11, the first switch module 12-3 includes an inductor L₁, a first switch S₁, a second switch S₂, a third switch S₃, and a fourth switch S₄. The first switch S₁ includes a first end connected to the first output end OUT1, and a second end connected to a first end of the inductor L₁. The second switch S₂ includes a first end connected to a second end of the inductor L₁, and a second end connected to the second input end IN2. Third switch S₃ includes a first end connected to the second output end OUT2, and a second end connected to the first end of the second switch S₂ and a second end of the inductor L₁. The fourth switch S₄ includes a first end connected to the second end of the first switch S₁ and the first end of the inductor L₁, and a second end connected to the third output end OUT3.

As shown in FIG. 11, the power converter 50 further includes a first capacitor C₁, a second capacitor C₂, and a third capacitor C₃. The first capacitor C₁ is connected between the first input end IN1 and the first output end OUT1, and configured to build a first voltage V₁. The second capacitor C₂ is connected between the first output end OUT1 and the second output end OUT2, and configured to build a second voltage V₂. The third capacitor C₃ is connected between the second input end IN2 and the second output end OUT2, and configured to build a third voltage V₃. In this embodiment, the power source 11 is a DC power source, and connected between the first input end IN1 and the second input end IN2. The first switch S₁, the second switch S₂, the third switch S₃, and the fourth switch S₄ are N-type synchronous rectification switches.

As shown in FIG. 11, the power converter 50 further includes a second switch module 12-4 and a fourth capacitor C₄. The second switch module 12-4 includes a first switch S₁, a second switch S₂, a third switch S₃, and a fourth switch S₄. A first end of the first switch S₁ is connected to the first input end IN1, a second end of the second switch S₂ is connected to the third output end OUT3, a first end of the third switch S₃ is connected to the first output end OUT1, and a second end of the fourth switch S₄ is connected to the second output end OUT2. The fourth capacitor C₄ is connected between the third output end OUT3 and the second input end IN2.

In addition, the first load 91 is connected between the first input end IN1 and the first output end OUT1, the second load 92 is connected between the first output end OUT1 and the second output end OUT2, the third load 93 is connected between the second output end OUT2 and the third output end OUT3, and the fourth load 94 is connected between the third output end OUT3 and the second input end IN2.

In another embodiment, the power source 11 is an AC power source, and the first switch S₁, the second switch S₂, the third switch S₃, and the fourth switch S₄ are back-to-back bidirectional switches. Therefore, adapting to different positive and negative half cycles of the AC power source, the purpose of capacitor voltage adjustment can be achieved through the back-to-back bidirectional switch.

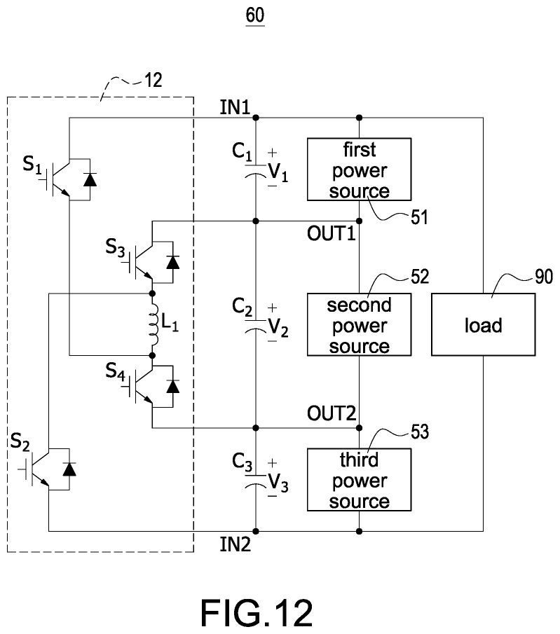

Please refer to FIG. 12, which shows a circuit diagram of the power converter 60 according to a sixth embodiment of the present disclosure. In the embodiment, when multiple loads supply power to the power source 11. One of the multiple loads is a first power source 51, and the first power source 51 is connected between the first input end IN1 and the first output end OUT1. One of the multiple loads is a second power source 52, and the second power source 52 is connected between the first output end OUT1 and the second output end OUT2. One of the multiple loads is a third power source 53, and the third power source 53 is connected between the second input end IN2 and the second output end OUT2. In this embodiment, the power source 11 serves as a load 90 connected between the first input end IN1 and the second input end IN2. In this embodiment, the first power source 51 and the first capacitor C₁ may be a battery, such as but not limited to a supercapacitor, a lithium battery, or a lead-acid battery. Similarly, the second power source 52 and the second capacitor C₂, and the third power source 53 and the third capacitor C₃ are both batteries. Therefore, the stable input voltage is provided by the battery, and the switches S₁, S₂, S₃, S₄ of the first switch module 12 are controlled as described above so as to achieve a bidirectional power flow, stabilize the battery voltage for charging and discharging, and provide the demand for the power source 11 (i.e., the load 90).

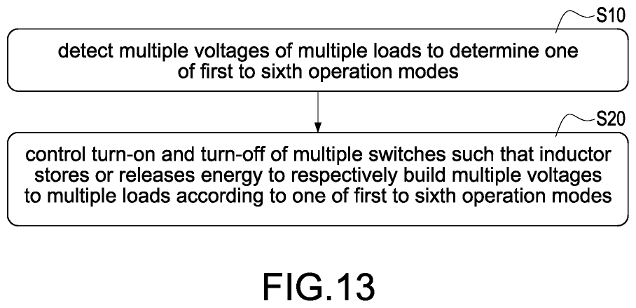

Please refer to FIG. 13, which shows a flowchart of a power conversion method according to the present disclosure. The description will be made in conjunction with one of the embodiments of different power converters disclosed above. The power converter includes a first switch S₁, a second switch S₂, a third switch S₃, a fourth switch S₄, an inductor L₁, a first capacitor C₁, a second capacitor C₂, and a third capacitor C₃. The power conversion method includes steps as follows. First, detect multiple voltages of multiple loads to determine one of first to sixth operation modes (step S10). Afterward, control the turn-on and turn-off of the first switch S₁, the second switch S₂, the third switch S₃, and the fourth switch S₄ to make the inductor L₁ store or release energy to respectively build a first voltage V₁, a second voltage V₂, and a third voltage V₃ to multiple loads according to one of first to sixth operation modes (step S20).

In the first operation mode, the method includes a step of: turning on the first switch S₁ so that the inductor L₁ stores energy stored in the first capacitor C₁ to build a first voltage V₁ on the inductor L₁, and turning off the first switch S₁ so that the first voltage V₁ of the inductor L₁ releases energy to the second capacitor C₂ to build a second voltage V₂ on the second capacitor C₂.

In the second operation mode, the method includes a step of: turning on the third switch S₃ and the fourth switch S₄ so that the inductor L₁ stores energy stored in the second capacitor C₂ to build a second voltage V₂ on the inductor L₁, and turning off the fourth switch S₄ and turning on the third switch S₃ so that the second voltage V₂ of the inductor L₁ releases energy to the first capacitor C₁ to build a first voltage V₁ on the first capacitor C₁.

In the third operation mode, the method includes a step of: turning on the third switch S₃ and the fourth switch S₄ so that the inductor L₁ stores energy stored in the second capacitor C₂ to build a second voltage V₂ on the inductor L₁, and turning off the third switch S₃ and turning on the fourth switch S₄ so that the second voltage V₂ of the inductor L₁ releases energy to the third capacitor C₃ to build a third voltage V₃ on the third capacitor C₃.

In the fourth operation mode, the method includes a step of: turning on the second switch S₂ so that the inductor L₁ stores energy stored in the third capacitor C₃ to build a third voltage V₃ on the inductor L₁, and turning off the second switch S₂ so that the third voltage V₃ of the inductor L₁ releases energy to the second capacitor C₂ to build a second voltage V₂ on the second capacitor C₂.

In the fifth operation mode, the method includes a step of: turning on the third switch S₃ and the fourth switch S₄ so that the inductor L₁ stores energy stored in the second capacitor C₂ to build a second voltage V₂ on the inductor L₁, and turning off the third switch S₃ and the fourth switch S₄ so that the energy stored in the inductor L₁ releases to the first capacitor C₁, the second capacitor C₂, and the third capacitor C₃ to build a first voltage V₁ on the first capacitor C₁, a second voltage V₂ on the second capacitor C₂, and a third voltage V₃ on the third capacitor C₃.

In the sixth operation mode, the method includes a step of: turning on the first switch S₁ and the second switch S₂ so that the inductor L₁ stores energy stored in the first capacitor C₁, the energy stored in the second capacitor C₂, and the energy stored in the third capacitor C₃ to build a total voltage of V₁+V₂+V₃ (that is, the sum of the first voltage V₁, the second voltage V₂, and the third voltage V₃) on the inductor L₁, and turning off the first switch S₁ or the second switch S₂ so that the total voltage of V₁+V₂+V₃ of the inductor L₁ releases energy to the second capacitor C₂ to build a second voltage V₂ on the second capacitor C₂.

In conclusion, the present disclosure has following features and advantages:
1. The power converter proposed in the present disclosure controls the voltages of the capacitor units through duty cycle adjustment of the switches to reduce the number of components and achieve the advantages of small size and low cost.
2. Through the energy storage and release of the inductor, and the control of multiple switches, the energy transfer between the voltages of the capacitor units can be controlled, and the voltages of the capacitor units can be adjusted to meet the requirements of different loads.

The present disclosure has been described with reference to the preferred embodiment thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A power converter, coupled between a power source and multiple loads, the power converter comprising:
a first switch module comprising:
an inductor comprising a first end and a second end;
a first switch comprising a first end connected to a first input end, and a second end connected to the first end of the inductor;
a second switch comprising a first end connected to the second end of the inductor, and a second end connected to a second input end;
a third switch comprising a first end connected to a first output end, and a second end connected to the first end of the second switch and the second end of the inductor; and
a fourth switch comprising a first end connected to the second end of the first switch, and a second end connected to a second output end,
wherein the first switch, the second switch, the third switch, and the fourth switch are configured to be turned on or off, such that the inductor stores or releases energy to convert the power source into multiple voltages to the multiple loads.

2. The power converter of claim 1, further comprising:
a first capacitor connected between the first input end and the first output end, and configured to build a first voltage;
a second capacitor connected between the first output end and the second output end, and configured to build a second voltage; and
a third capacitor connected between the second input end and the second output end, and configured to build a third voltage;
wherein the power source is a DC power source connected between the first input end and the second input end; and the first switch, the second switch, the third switch, and the fourth switch are N-type synchronous rectification switches.

3. The power converter of claim 1, further comprising:
a first capacitor string comprising multiple first capacitors connected in series, connected between the first input end and the first output end, and configured to build a first voltage;
a second capacitor string comprising multiple second capacitors connected in series, connected between the first output end and the second output end, and configured to build a second voltage; and
a third capacitor string comprising multiple third capacitors connected in series, connected between the second input end and the second output end, and configured to build a third voltage;
wherein the power source is a DC power source connected between the first input end and the second input end; and the first switch, the second switch, the third switch, and the fourth switch are N-type synchronous rectification switches.

4. The power converter of claim 1, wherein a first load of the multiple loads is connected between the first input end and the first output end, a second load of the multiple loads is connected between the first output end and the second output end, and a third load of the multiple loads is connected between the second input end and the second output end.

5. The power converter of claim 1, wherein the power source is an AC power source, and the first switch, the second switch, the third switch, and the fourth switch are back-to-back bidirectional switches.

6. The power converter of claim 1, further comprising:
a second switch module, wherein a first end of a third switch of the second switch module is connected to the second output end, and a second end of a fourth switch of the second switch module is connected to a third output end; and
a fourth capacitor connected between the third output end and the second input end, and configured to build a fourth voltage.

7. The power converter of claim 1, wherein, when the multiple loads supply power to the power source:
one of the multiple loads serves as a first power source connected between the first input end and the first output end;
one of the multiple loads serves as a second power source connected between the first output end and the second output end;
one of the multiple loads serves as a third power source connected between the second input end and the second output end; and
the power source serves as a load connected between the first input end and the second input end.

8. A power converter, coupled between a power source and multiple loads, the power converter comprising:
a first switch module comprising:
an inductor comprising a first end and a second end,
a first switch comprising a first end connected to a first output end, and a second end connected to the first end of the inductor;
a second switch comprising a first end connected to the second end of the inductor, and a second end connected to a second input end;
a third switch comprising a first end connected to a second output end, and a second end connected to the first end of the second switch and the second end of the inductor; and
a fourth switch comprising a first end connected to the second end of the first switch and the first end of the inductor, and a second end connected to a third output end.

9. The power converter of claim 8, further comprising:
a first capacitor connected between a first input end and the first output end, and configured to build a first voltage;
a second capacitor connected between the first output end and the second output end, and configured to build a second voltage; and
a third capacitor connected between the second input end and the second output end, and configured to build a third voltage;
wherein the power source is a DC power source connected between the first input end and the second input end; and the first switch, the second switch, the third switch, and the fourth switch are N-type synchronous rectification switches.

10. The power converter of claim 9, further comprising:
a second switch module, wherein a first end of a first switch of the second switch module is connected to the first output end, a second end of a second switch of the second switch module is connected to the third output end, a first end of a third switch of the second switch module is connected to the first output end, and a second end of a fourth switch of the second switch module connected to the second output end; and
a fourth capacitor connected between the third output end and the second input end.

11. The power converter of claim 9, wherein a first load of the multiple loads is connected between the first input end and the first output end, a second load of the multiple loads is connected between the first output end and the second output end, a third load of the multiple loads is connected between the second output end and the third output end, and a fourth load of the multiple loads is connected between the third output end and the second input end.

12. The power converter of claim 8, wherein the power source is an AC power source; and the first switch, the second switch, the third switch, and the fourth switch are back-to-back bidirectional switches.

13. A power conversion method, used for the power converter of claim 1, the power converter comprising a first switch, a second switch, a third switch, a fourth switch, an inductor, a first capacitor, a second capacitor, and a third capacitor, the power conversion method comprising steps of:
detecting multiple voltages of multiple loads to determine one of a first operation mode, a second operation mode, a third operation mode, a fourth operation mode, a fifth operation mode, and a sixth operation mode; and
controlling turn-on and turn-off of the first switch, the second switch, the third switch, and the fourth switch, such that the inductor stores or releases energy to respectively build a first voltage, a second voltage, and a third voltage to the multiple loads according to one of the six operation modes.

14. The power conversion method of claim 13, in the first operation mode, comprising steps of:
turning on the first switch, so that the inductor stores the energy stored in the first capacitor to build the first voltage on the inductor; and
turning off the first switch, so that the first voltage of the inductor releases energy to the second capacitor to build the second voltage on the second capacitor.

15. The power conversion method of claim 13, in the second operation mode, comprising steps of:
turning on the third switch and the fourth switch, so that the inductor stores the energy stored in the second capacitor to build the first voltage on the inductor; and
turning off the fourth switch and turning on the third switch, so that the second voltage of the inductor releases energy to the first capacitor to build the first voltage on the first capacitor.

16. The power conversion method of claim 13, in the third operation mode, comprising steps of:
turning on the third switch and the fourth switch, so that the inductor stores the energy stored in the second capacitor to build the second voltage on the inductor; and
turning off the third switch and turning on the fourth switch, so that the second voltage of the inductor releases energy to the third capacitor to build the third voltage on the third capacitor.

17. The power conversion method of claim 13, in the fourth operation mode, comprising steps of:
turning on the second switch, so that the inductor stores the energy stored in the third capacitor to build the third voltage on the inductor; and
turning off the second switch, so that the third voltage of the inductor releases energy to the second capacitor to build the second voltage on the second capacitor.

18. The power conversion method of claim 13, in the fifth operation mode, comprising steps of:
turning on the third switch and the fourth switch, so that the inductor stores the energy stored in the second capacitor to build the second voltage on the inductor; and
turning off the third switch and the fourth switch, so that the energy stored in the inductor releases to the first capacitor, the second capacitor, and the third capacitor to build the first voltage on the first capacitor, the second voltage on the second capacitor, and the third voltage on the third capacitor.

19. The power conversion method of claim 13, in the sixth operation mode, comprising steps of:
turning on the first switch and the second switch, so that the inductor stores the energy stored in the first capacitor, the energy stored in the second capacitor, and the energy stored in the third capacitor to build a total voltage on the inductor; and
turning off the first switch and the second switch, so that the inductor releases the total voltage to the second capacitor to build the second voltage on the second capacitor.
